(19) United States
(12) Patent Application Publication
(10) Pub. No.: US 2024/0391449 A1
(43) Pub. Date: Nov. 28, 2024

(54) CONTROL ARRANGEMENT AND METHOD FOR SHUTTING DOWN A COMBUSTION ENGINE

(71) Applicant: Scania CV AB, Sodertalje (SE)

(72) Inventors: Daniel STÅHL, Enkoping (SE); Martin BERGLUND, Vagnharad (SE); Mats HÄRDELIN, Ronninge (SE); Hans GÖRANSSON, Alvsjo (SE)

(73) Assignee: Scania CV AB, Sodertalje (SE)

(21) Appl. No.: 18/660,608

(22) Filed: May 10, 2024

(30) Foreign Application Priority Data
May 22, 2023 (SE) 2350612-4

(51) Int. Cl. B60W 10/06; B60W 20/15

(52) U.S. Cl. CPC B60W 10/06; B60W 20/15; B60W 2710/0666

(57) ABSTRACT

A control arrangement and a method for shutting down a combustion engine of a powertrain of a vehicle are disclosed. The vehicle comprises an intake air throttle arranged in an intake pipe of the combustion engine, and at least one auxiliary brake selected from the group consisting of; an exhaust brake and an electrical machine configured to operate as a generator. The method comprises in response to a command for shutdown of the combustion engine, stopping fuel injection to the combustion engine; controlling the intake air throttle so as to reduce the air intake to the combustion engine; and activating the at least one auxiliary brake so as to brake the combustion engine, if not already activated.

### TECHNICAL FIELD

The present disclosure relates in general to a method for shutting down a combustion engine of a powertrain of a vehicle. The present disclosure further relates in general to a control arrangement configured to shut down a combustion engine of a powertrain of a vehicle, as well as a vehicle comprising said control arrangement. The present disclosure further relates in general to a computer program and a computer-readable medium.

### BACKGROUND

Combustion engines of heavy vehicles are today typically shut down by simply stopping fuel injection. This method causes oscillations and vibrations due to the rotational irregularity of the combustion engine during the shutdown event, which in turn reduces comfort for e.g. a driver of the vehicle. The oscillations and vibrations generated by the combustion engine are transmitted through the powertrain as well as other constituent components, such as the chassis frames, of the vehicle before being damped out. In case the frequency of said oscillations/vibrations coincides with the natural frequency of other constituent components of the vehicle, such other constituent components may also start to oscillate due to resonance. Moreover, due to the inertia of the combustion engine, the transition from an initial rotational speed (i.e. the rotational speed at the start of the shutdown event) to standstill, during which the oscillations and vibrations may be generated, takes a relatively long time for a combustion engine of a heavy vehicle, especially compared to a passenger car.

It has previously been proposed to address the problem of oscillations and vibrations during shutdown of the combustion engine by closing an air throttle valve arranged in an intake pipe of the combustion engine, thereby reducing compression in the combustion engine. An example of a method comprising closing an air throttle valve during a shutdown event of the combustion engine for the purpose of reducing vibration is disclosed in JP 2008-298031 A. Although this may increase the comfort during shutdown, it does not completely avoid the problem and may in worst case extend the transition to standstill. The latter could also cause a delay in restart of the combustion engine, if a command therefore would be generated during the shutdown event, since it is not possible to restart the combustion engine with a conventional starter motor until after the shutdown event has been completed.

SE 542021 C2 discloses a method for shutting down a combustion engine of a vehicle powertrain, said vehicle powertrain comprising a combustion engine, a gearbox and a clutch arranged between the combustion engine and the gearbox. The method comprises securing the input shaft of the gearbox in a non-rotating state and engaging the clutch so as to provide a braking torque to the outgoing shaft of the combustion engine. Thereby, the combustion engine can be shut down faster than achievable by simply stopping fuel injection which in turn improves the comfort. Although said method works very well, it may increase wear of the clutch, and also requires that the input shaft of the gearbox can be secured in a non-rotating state.

### SUMMARY

The object of the present invention is to enable an improved shutdown of a combustion engine of a vehicle powertrain.

The object is achieved by the subject-matter of the appended independent claim(s).

The present disclosure provides a method, performed by a control arrangement, for shutting down a combustion engine of a powertrain of a vehicle. Said vehicle comprises an intake air throttle arranged in an intake pipe of the combustion engine. The vehicle further comprises at least one auxiliary brake selected from the group consisting of an exhaust brake and an electrical machine configured to operate as a generator. The method comprises, in response to a command for shutdown of the combustion engine, the following steps:
stopping fuel injection to the combustion engine,
controlling the intake air throttle so as to reduce the air intake to the combustion engine, and
activating the at least one auxiliary brake so as to brake the combustion engine, if not already activated.

By means of the herein described method, a comfortable and fast shutdown of the combustion engine may be achieved. More specifically, the herein described method leads to a considerably faster shutdown of the combustion engine, compared to only stopping fuel injection, which in turn reduces the time that oscillations and vibrations may be generated and consequently the amount thereof, at the same time as the amplitude of oscillations and vibrations is reduced. The fact that the method results in a fast shutdown of the combustion engine may also reduce the time until the combustion engine may be restarted in case a command for starting the combustion engine would be generated during the shutdown event.

The step of controlling the intake air throttle so as to reduce the air intake to the combustion engine may comprise controlling the intake air throttle to a partially closed position. Thereby, the air intake to the combustion engine is, albeit reduced, not completely prevented. This has the advantage of avoiding, or at least reducing the risk of, vacuum being formed in the cylinders of the combustion engine during the shutdown. Thereby, a faster restart of the combustion engine may be enabled.

The method may further comprise a step of, in response to a determination that the rotational speed of the combustion engine is reduced below a threshold speed, controlling the intake air throttle so as to increase the air intake to the combustion engine. This will e.g. enable a faster restart of the combustion engine.

In case said at least one auxiliary brake is an exhaust brake, the step of activating the at least one auxiliary brake (here the exhaust brake) so as to brake the combustion engine may be performed prior to, or simultaneously with, the step of stopping fuel injection. Activation of an exhaust brake may typically take some time, which means that there is a delay before the desired braking torque therefrom is actually obtained. Therefore, the activation of the exhaust brake is suitably initiated, at the latest, at the point in time when fuel injection is stopped to ensure that the combustion engine has not reached a rotational speed at which resonance may occur before a braking thereof is achieved by the exhaust brake.

The method may further comprise, in case said at least one auxiliary brake is an exhaust brake and the vehicle further comprises an electrical machine, a step of controlling the electrical machine to apply a torque to the combustion engine according to a torque profile so as to dampen oscillations in a crankshaft of the combustion engine. Thereby, the amplitude of the oscillations generated by the combustion engine may be further reduced.

In case said at least one auxiliary brake is an electrical machine configured to operate as a generator, the method may further comprise a step of controlling the electrical machine to apply a braking torque to the combustion engine according to a torque profile so as to dampen oscillations in a crankshaft of the combustion engine while reducing the rotational speed of the crankshaft. This further reduces the amplitude of the oscillations and vibrations generated by the combustion engine, which in turn improves the comfort during the shutdown event.

The present disclosure further relates to a computer program comprising instructions which, when executed by a computer, cause the computer to carry out the method as described above.

The present disclosure further relates to a computer-readable medium comprising instructions which, when executed by a computer, cause the computer to carry out the method as described above.

Moreover, the present disclosure provides a control arrangement configured to shut down a combustion engine of a powertrain of a vehicle. Said vehicle comprises an intake air throttle arranged in an intake pipe of the combustion engine. The vehicle further comprises at least one auxiliary brake selected from the group consisting of an exhaust brake and an electrical machine configured to operate as a generator. The control arrangement is configured to, in response to a command for shutdown of the combustion engine:
stop fuel injection to the combustion engine,
control the intake air throttle so as to reduce the air intake to the combustion engine, and
activate the at least one auxiliary brake so as to brake the combustion engine, if not already activated.

The control arrangement provides the same advantages as described above with reference to the corresponding method for shutting down a combustion engine of a powertrain of a vehicle.

Moreover, the present disclosure provides a vehicle comprising a powertrain comprising a combustion engine. The vehicle further comprises an intake air throttle arranged in an intake pipe of the combustion engine, and at least one auxiliary brake selected from the group consisting of an exhaust brake and an electrical machine configured to operate as a generator. The vehicle further comprises the control arrangement as described above.

The vehicle may be a land-based heavy vehicle, such as a bus or a truck. The vehicle may be a hybrid vehicle, such as a hybrid electric vehicle (HEV), a plug-in hybrid vehicle (PHEV) or a mild hybrid vehicle (mHEV), or be a vehicle driven solely by a combustion engine. Furthermore, the vehicle may be a vehicle configured to a driven fully or in part by a driver. Alternatively, the vehicle may be a fully autonomous vehicle.

### BRIEF DESCRIPTION OF DRAWINGS

FIG. 1 schematically illustrates a side view of an example of a vehicle,

FIG. 2 schematically illustrates a first exemplifying embodiment of a powertrain of a vehicle,

FIG. 3 schematically illustrates a second exemplifying embodiment of a powertrain of a vehicle,

FIG. 4 schematically illustrates a cross-section of an example of a cylinder 40 of a combustion engine,

FIG. 5 represents a flowchart schematically illustrating one exemplifying embodiment of the herein described method for shutting down a combustion engine of a powertrain of a vehicle,

FIG. 6 schematically illustrates an exemplifying embodiment of a device which may comprise, consist of, or be comprised in a control arrangement configured to perform the herein described method.

### DETAILED DESCRIPTION

The invention will be described in more detail below with reference to exemplifying embodiments and the accompanying drawings. The invention is however not limited to the exemplifying embodiments discussed and/or shown in the drawings, but may be varied within the scope of the appended claims. Furthermore, the drawings shall not be considered drawn to scale as some features may be exaggerated in order to more clearly illustrate the invention or features thereof.

In the present disclosure, the term “torque profile” is used to describe a profile defining a variation of torque over time.

The present disclosure provides a method for shutting down a combustion engine of a powertrain of a vehicle. The method is performed by a control arrangement configured therefore. The vehicle comprises an intake air throttle arranged in an intake pipe of the combustion engine. Said intake throttle may suitably be an electronically controlled intake air throttle, but is not limited thereto. The vehicle further comprises at least one auxiliary brake selected from the group consisting of an exhaust brake and an electrical machine configured to operate as a generator. In addition to the combustion engine, the powertrain may comprise a gearbox configured to selectively transfer propulsion torque from the combustion engine to a drive shaft of the vehicle powertrain. The combustion engine may optionally be connected to the gearbox via a clutch. The vehicle powertrain may also comprise one or more electrical machines which may be configured to operate as a motor for the purpose of providing propulsion torque to the vehicle. Preferably, at least one of said one or more electrical machines may also be operated as a generator for the purpose of providing a braking torque to the vehicle, in which case it may also serve as said at least one auxiliary brake mentioned above.

The herein described method for shutting down a combustion engine of a powertrain of a vehicle comprises a step of stopping fuel injection to the combustion engine. The method further comprises a step of controlling the intake air throttle so as to reduce the air intake to the combustion engine. A reduced air intake to the combustion engine leads to a reduced compression, which in turn leads to a reduction of the amplitude of the oscillations and vibrations caused by the irregularities in the rotational speed of the crankshaft and flywheel of the combustion engine. The method further comprises activating the at least one auxiliary brake so as to brake the combustion engine, if not already activated. Described differently, the method comprises a step of activating said at least one auxiliary brake so as to provide a braking torque to the combustion engine. By braking the combustion engine using said at least one auxiliary brake, the reduction of rotational speed of the combustion engine to standstill will be considerably faster compared to shutting down the combustion engine by only stopping fuel injection. The reduced time of the shutdown event also means that there will be less time for the oscillations and vibrations to be generated. The fact that both the amplitude and amount of oscillations and vibrations are reduced by the herein described method also results in that the oscillations and vibrations will be more quickly damped out in the vehicle.

Each of the above described steps of the herein described method is performed in response to a command for shutdown of the combustion engine. Furthermore, the above described steps of the herein described method may be initiated either simultaneously or initiated in any order desired.

It should here be noted that an engine shut down may be commanded in accordance with any process as known in the art. For example, a command for shutdown of the combustion engine may be generated by a driver of the vehicle, for example by turning off an ignition switch of the vehicle. Alternatively, an engine shutdown may be commanded by an engine control system configured to automatically shut down the combustion engine. Such a system may for example be configured to automatically shut down the combustion engine when the vehicle is at standstill for a predetermined minimum time, for example when stopping at traffic lights, when stopping for a road bridge opening, or the like. Alternatively, or additionally, such system may be configured to automatically shut down the combustion engine during driving of the vehicle (i.e. while the vehicle is in motion) for the purpose of reducing fuel consumption and/or emissions. Examples of situations where this may be applicable include for example during coasting with combustion engine off, or, in case of a hybrid vehicle, during electric operation of the vehicle powertrain. The command for shutdown of the combustion engine, irrespectively of how it is generated (i.e. its origin), may be detected by the control arrangement configured to shut down the combustion engine. Alternatively, the control arrangement may itself comprise a control system configured to automatically shut down a combustion engine, in which case the control arrangement may also be configured to generate the command for shutdown of the combustion engine based on a determination that one or more predefined conditions are fulfilled.

The step of controlling the intake air throttle so as to reduce the air intake to the combustion engine may comprise controlling the intake air throttle to a partially closed position. Thereby, the air intake to the combustion engine is, albeit reduced, not completely prevented. This has the advantage of avoiding, or at least reducing the risk of, vacuum being formed in the cylinders of the combustion engine during the shutdown. Thereby, a faster restart of the combustion engine, during the shutdown event or after it has been shut down, may be enabled. Restart of the combustion engine during the shutdown event or after shutdown may, in case the vehicle is in motion and has a sufficiently high travelling speed, be made by closing the powertrain so as to connect the driving wheels to the combustion engine to thereby increase the rotational speed of the combustion engine, and initiate fuel injection when the rotational speed of the combustion engine is sufficiently high. In case the vehicle is at standstill, or is travelling at a low speed, restarting of the combustion engine after it has been shut down may be made using a conventional starter motor. Moreover, depending on the configuration of the combustion engine with its cylinders and associated pistons, controlling the intake air throttle to a partially closed position may lead to a reduced risk of unwanted oil carryover into the combustion chamber of the cylinders of the combustion engine.

Alternatively, the step of controlling the intake air throttle so as to reduce the air intake to the combustion engine may comprise controlling the intake air throttle to a closed position. This leads to a further reduction of the amplitude of the oscillations, but will likely lead to vacuum being created in the cylinders during the shutdown event.

The method may further comprise a step of, in response to a determination that the rotational speed of the combustion engine is reduced below a threshold speed during the shutdown event, controlling the intake air throttle so as to increase the air intake to the combustion engine. This will e.g. enable a faster restart of the combustion engine during the shutdown or after it has been shut down. The threshold speed may suitably be the lowest rotational speed of the combustion engine which may lead to a frequency of the oscillations of the combustion engine coinciding with the natural frequency of another constituent component of the vehicle, such as a chassis frame and/or a shaft of the powertrain. In other words, the threshold speed may suitably be the lowest rotational speed of the combustion engine which may cause resonance in one or more constituent components of the vehicle.

As evident from the above, the method comprises activating (if not already active) an auxiliary brake of the vehicle so as to brake the combustion engine in response to a command for shutdown of the combustion engine, wherein said auxiliary brake may be either an exhaust brake or an electrical machine configured to operate as a generator. The vehicle may naturally comprise other auxiliary brakes, such as a compression brake and/or a hydraulic retarder. However, using a compression brake for the purpose of braking the combustion engine may lead to considerable noise that may be seen as disturbing. Furthermore, a hydraulic retarder is generally connected to an output shaft of the gearbox of the powertrain, and dependent of the rotational speed of said output shaft for providing the necessary hydraulic pressure. Hence, such a hydraulic retarder cannot be used for braking the combustion engine in case the vehicle is at standstill.

In case the auxiliary brake is already active when the command for shutdown of the combustion engine is generated and applies a braking torque to the combustion engine, the method may further comprise controlling the auxiliary brake so as to increase the braking torque applied by the auxiliary brake to the combustion engine.

The method may further comprise, in case said at least one auxiliary brake is an exhaust brake and the vehicle further comprises an electrical machine, a step of controlling the electrical machine to apply a torque to the combustion engine according to a torque profile so as to dampen oscillations in a crankshaft of the combustion engine. In order to do so, the electrical machine may be alternatively operated as a motor and a generator. By means of said step, the amplitude of the oscillations generated by the combustion engine may be further reduced which also means that they may be damped out more quickly by the powertrain (in case the combustion engine has not be disconnected from the rest of the powertrain) and/or other constituent components of the vehicle. Said electrical machine may suitably be an electrical machine of the vehicle powertrain, such as an electrical machine configured to be operated as a motor for the purpose of propelling the vehicle and which is also configured to operate as a generator. It is however also possible that a specifically designated electrical machine, not comprised in the powertrain but being connectable to the combustion engine, may be used for dampening the oscillations in the crankshaft of the combustion engine by applying torque according to a torque profile.

In case the auxiliary brake activated so as to brake the combustion engine in accordance with the herein described method is an electrical machine configured to operate as a generator, said electrical machine is suitably an electrical machine of the powertrain, i.e. an electrical machine that is also configured to operate as a motor for the purpose of providing propulsion torque to the vehicle powertrain. In such a case, the method may further comprise a step of controlling the electrical machine to apply a braking torque to the combustion engine according to a torque profile so as to, in addition to braking the combustion engine, dampen oscillations in the crankshaft of the combustion engine. This may comprise controlling the electrical machine to alternately apply a negative torque and a positive torque, respectively, while the sum thereof results in a braking torque applied to the combustion engine. This may further reduce the amplitude of the oscillations and vibrations, and thereby an increased comfort during the shutdown event.

The performance of the herein described method for shutting down a combustion engine of a powertrain of a vehicle may be governed by programmed instructions. These programmed instructions may take the form of a computer program which, when executed by a computer, cause the computer to effect desired forms of control action. Such a computer may for example be comprised in the control arrangement as described herein. A computer is in the present disclosure considered to mean any hardware or hardware/firmware device implemented using processing circuitry such as, but not limited to, a processor, Central Processing Unit (CPU), a controller, an arithmetic logic unit (ALU), a digital signal processor, a microcomputer, a field programmable gate array (FPGA), a System-on-Chip (SoC), a programmable logic unit, a microprocessor, an application-specific integrated circuit, or any other device capable of electronically performing operations in a defined manner.

The above described programmed instructions, which may take the form of a computer program, may be stored on a computer-readable medium. Hence, the present disclosure also relates to a computer-readable medium storing instructions, which when executed by computer, cause the computer to carry out the herein described method for shutting down a combustion engine of a powertrain of a vehicle. The computer-readable medium may be a non-transitory computer-readable medium, such as a tangible electronic, magnetic, optical, infrared, electromagnetic, and/or semiconductor system, apparatus, and/or device.

The present disclosure further relates to a control arrangement configured to shut down a combustion engine of a powertrain of a vehicle. The control arrangement may be configured to perform any one of the steps of the method for shutting down a combustion engine of a powertrain of a vehicle as described above.

More specifically, the present disclosure provides a control arrangement configured to shut down a combustion engine of a powertrain of a vehicle. Said vehicle comprises an intake air throttle arranged in an intake pipe of the combustion engine. The vehicle further comprises at least one auxiliary brake selected from the group consisting of an exhaust brake and an electrical machine configured to operate as a generator. The control arrangement is configured to, in response to a command for shutdown of the combustion engine:
stop fuel injection to the combustion engine,
control the intake air throttle so as to reduce the air intake to the combustion engine, and
activate the at least one auxiliary brake so as to brake the combustion engine, if not already activated.

The control arrangement may comprise one or more control units. In case of the control arrangement comprising a plurality of control units, each control unit may be configured to control a certain function or a certain function may be divided between more than one control units. The control arrangement may be a control arrangement of the powertrain of the vehicle, for example a control arrangement of an engine management system of the vehicle. Alternatively, the control arrangement may be any other control arrangement of the vehicle but configured to communicate with an engine management system of the vehicle for the purpose of performing the herein described method.

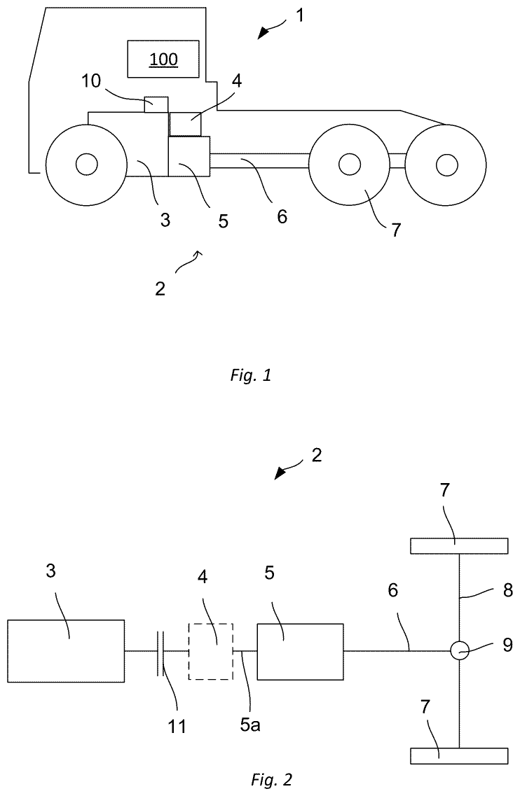

FIG. 1 schematically illustrates a side view of an example of a vehicle 1. The vehicle 1 comprises a powertrain 2 comprising a combustion engine 3, an electrical machine 4, and a gearbox 5. An output shaft 6 of the gearbox 5 is connected to a drive shaft (not shown) and the associated drive wheels 7. The electrical machine 4 is configured to operate as a motor for the purpose of propelling the vehicle 1 and/or as a generator for the purpose of functioning as an auxiliary brake of the vehicle 1. The vehicle 1 may further comprise an auxiliary brake in the form of an exhaust brake 10. The vehicle further comprises a control arrangement 100 configured to shut down the combustion engine 3.

FIG. 2 schematically illustrates a first exemplifying embodiment of a powertrain 2, which may be comprised in a vehicle, such as the vehicle 1 shown in FIG. 1. The powertrain 2 comprises a combustion engine 3 and a gearbox 5 configured to selectively transfer propulsion torque from the combustion engine 3 to drive wheels 7. The gearbox may for example be a conventional automated manual transmission, but is not limited thereto. The combustion engine 3 is connectable to an input shaft 5a of the gearbox 5 by a clutch 11. The output shaft 6 of the gearbox 5 may be connected to a drive shaft 8, with its associated drive wheels 7, via a differential 9. The drive shaft 8, differential 9 and drive wheels 7 are comprised in the vehicle powertrain 2.

The powertrain 2 may further comprise an electrical machine 4. The electrical machine 4 may for example be connected to the input shaft 5a of the gearbox 5 via a planetary gear (not shown). The electrical machine 4 may be configured to alternately operate as a motor and as a generator. For example, the electrical machine 4 may be operated as a generator for the purpose of providing a braking torque to the powertrain 2. In such a case, it may be used to generate electric power which may be stored in an energy storage device (not shown) and later on used for powering the electrical machine 4 when it serves as a motor. Thus, the electrical machine 4 may be configured to function as a regenerative brake, which is a type of auxiliary brake system of a vehicle.

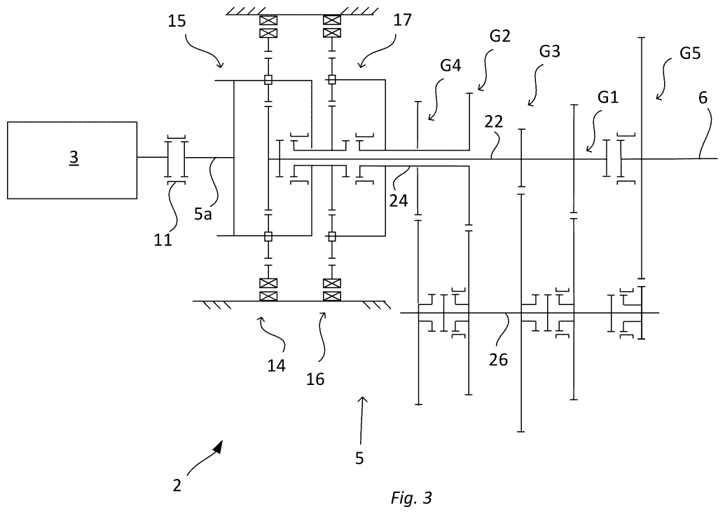

FIG. 3 schematically illustrates a second exemplifying embodiment of a powertrain 2, which may be comprised in a vehicle, such as the vehicle 1 shown in FIG. 1. According to the second exemplifying embodiment, the powertrain 2 comprises three propulsion units, namely a combustion engine 3, a first electrical machine 14 and a second electrical machine 16. Each of the first and second electrical machines 14, 16 of the powertrain 2 may be operated alternatively as a motor and as a generator.

The powertrain 2 further comprises a gearbox 5 having an input shaft 5a and an output shaft 6. Albeit not shown in the figure for sake of brevity, the output shaft 6 of the gearbox 5 may be connected to a drive shaft with its associated drive wheels in the same way as described above in relation to the exemplified powertrain shown in FIG. 2.

The gearbox 5 comprises a first planetary gear 15 connected to a first main shaft 22 of the gearbox 5. The gearbox 5 further comprises a second planetary gear 17 connected to the first planetary gear 15 and to a second main shaft 24 of the gearbox 5. Moreover, the gearbox 5 comprises a layshaft 26 connectable to the output shaft 6 of the gearbox, for example via a gear pair G5. The gearbox 5 also comprises one or more gear pairs G1, G3 arranged between the first main shaft 22 and the layshaft 26, and one or more gear pairs G2, G4 arranged between the second main shaft 24 and the layshaft 26. The configuration of the gearbox described above inter alia has the advantage of enabling gearshifts to be performed without interruption of propelling torque.

The combustion engine 3 may optionally be connected to an input shaft 5a of the gearbox 5 via a clutch 11. The purpose of the clutch 11 is to enable disconnecting the combustion engine 3, for example when operating the powertrain solely by one or both of the electrical machines 14, 16. It should however be noted that the clutch may alternatively be omitted in view of the configuration of the gearbox as described above. The first electrical machine 14 is connectable to the first planetary gear 15. Furthermore, the second electrical machine 16 is connectable to the second planetary gear 17.

The powertrain 2 shown in FIG. 3 is described in detail in e.g. US 2016/053864 A1 and US 2017/015300 A1, and will therefore not be further described herein.

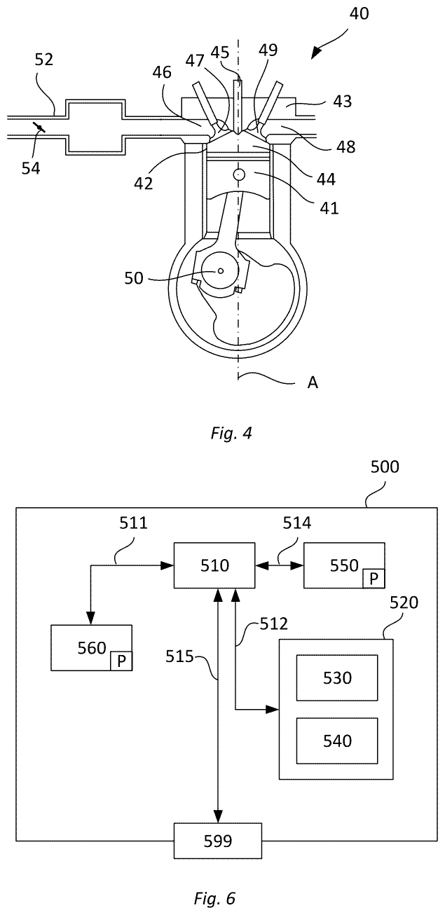

FIG. 4 schematically illustrates a cross-section of an example of a cylinder 40 of a combustion engine, such as the combustion engine 3 of any one of the powertrains 2 shown in FIG. 2 and FIG. 3. The combustion engine may be a diesel engine. A piston 41 is arranged in the cylinder 40. The piston 41 is configured to reciprocate within the cylinder 40 along a center axis A, thereby rotating the crankshaft 50 of the combustion engine. The piston 41 comprises a piston bowl (not shown) formed as a receptable in an upper surface of the piston. The piston bowl forms together with the internal walls 42 of the cylinder 40 and an internal surface of a cylinder head 43 a combustion chamber 44. A fuel injector 45, configured to inject fuel into the combustion chamber 44, may for example be positioned on the central axis A above the piston 41. An intake port 46 is provided in the cylinder head 43 for supply of air into the combustion chamber 44 via an intake valve 47. Furthermore, an exhaust port 48 is provided in the cylinder head 43 for evacuation of exhaust gases via an exhaust valve 49. The intake port 46 is connected to an intake pipe 52 of the combustion engine. An intake air throttle 54 may be arranged in the intake pipe 52.

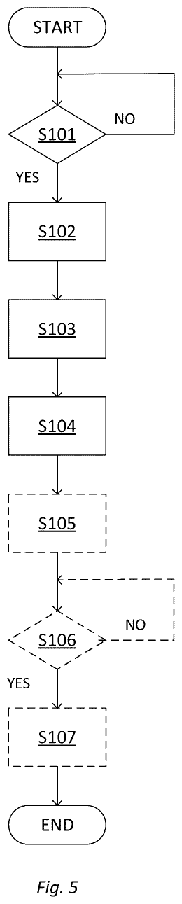

FIG. 5 represents a flowchart schematically illustrating one exemplifying embodiment of the herein described method for shutting down a combustion engine of a powertrain of a vehicle. As previously mentioned, the vehicle comprises an intake air throttle arranged in an intake air pipe of the combustion engine. The vehicle further comprises at least one auxiliary brake selected from the group consisting of an exhaust brake and an electrical machine configured to operate as a generator (and suitably also a motor). Optional steps of the method according to the exemplifying method are illustrated with dashed lines.

The method comprises a step S101 of determining whether a command for shutdown of the combustion engine has been generated. In case there is no command for shutdown of the combustion engine, the method may be reverted to start. However, in case a command for shutdown of the combustion engine has been generated, the method proceeds to subsequent steps.

The method comprises a step S102 of stopping fuel injection to the combustion engine.

The method further comprises a step S103 of controlling the intake throttle so as to reduce the air intake to the combustion engine. Thereby, compression is reduced. The intake throttle may for example be controlled to a partially closed position such that the air intake to the combustion engine is reduced but not completely prevented.

Furthermore, the method comprises a step S104 of activating, unless already activated, the at least one auxiliary brake so as to brake the combustion engine by applying a braking torque thereto.

It should here be noted that although the steps S102-S104 are illustrated in the figure as performed in their numerical order, the present disclosure is not limited thereto. For example, steps S102-S104 may be performed substantially simultaneously (i.e. in parallel) or in any order.

The method may further comprise a step S105 of controlling an electrical machine (which may or may not be the electrical machine that may be said at least one auxiliary brake) so as to apply a torque to the combustion engine according to a torque profile so as to dampen oscillations in the crankshaft of the combustion engine.

The method may further comprise a step S106 of determining whether the rotational speed of the combustion engine has been reduced below a threshold speed. Step S106 may be repeated until it is determined that the rotational speed has been reduced below said threshold speed. Thereafter, the method may comprise a step S107 of, in response to said determination, controlling the intake air throttle so as to increase the air intake to the combustion engine.

The method may thereafter be ended.

FIG. 6 schematically illustrates an exemplifying embodiment of a device 500. The control arrangement 100 described above may for example comprise the device 500, consist of the device 500, or be comprised in the device 500.

The device 500 comprises a non-volatile memory 520, a data processing unit 510 and a read/write memory 550. The non-volatile memory 520 has a first memory element 530 in which a computer program, e.g. an operating system, is stored for controlling the function of the device 500. The device 500 further comprises a bus controller, a serial communication port, I/O means, an A/D converter, a time and date input and transfer unit, an event counter and an interruption controller (not depicted). The non-volatile memory 520 has also a second memory element 540.

There is provided a computer program P that comprises instructions for shutting down a combustion engine of a powertrain of a vehicle, wherein said vehicle comprises an intake air throttle, arranged in an intake pipe of the combustion engine, and at least one auxiliary brake selected from the group consisting of an exhaust brake and an electrical machine configured to operate as a generator. The computer program comprises instructions for, in response to a command for shutdown of the combustion engine: stopping fuel injection to the combustion engine, controlling the intake air throttle so as to reduce the air intake to the combustion engine, and activating the at least one auxiliary brake so as to brake the combustion engine (unless said at least one auxiliary brake is already activated).

The program P may be stored in an executable form or in a compressed form in a memory 560 and/or in a read/write memory 550.

The data processing unit 510 may perform one or more functions, i.e. the data processing unit 510 may effect a certain part of the program P stored in the memory 560 or a certain part of the program P stored in the read/write memory 550.

The data processing device 510 can communicate with a data port 599 via a data bus 515. The non-volatile memory 520 is intended for communication with the data processing unit 510 via a data bus 512. The separate memory 560 is intended to communicate with the data processing unit 510 via a data bus 511. The read/write memory 550 is adapted to communicate with the data processing unit 510 via a data bus 514. The communication between the constituent components may be implemented by a communication link. A communication link may be a physical connection such as an optoelectronic communication line, or a non-physical connection such as a wireless connection, e.g. a radio link or microwave link.

When data are received on the data port 599, they may be stored temporarily in the second memory element 540. When input data received have been temporarily stored, the data processing unit 510 is prepared to effect code execution as described above.

Parts of the methods herein described may be affected by the device 500 by means of the data processing unit 510 which runs the program stored in the memory 560 or the read/write memory 550. When the device 500 runs the program, methods herein described are executed.

1. A method, performed by a control arrangement, for shutting down a combustion engine of a powertrain of a vehicle,
wherein said vehicle comprises:
an intake air throttle arranged in an intake pipe of the combustion engine, and
at least one auxiliary brake selected from the group consisting of: an exhaust brake and an electrical machine configured to operate as a generator,
the method comprising, in response to a command for shutdown of the combustion engine;
stopping fuel injection to the combustion engine;
controlling the intake air throttle so as to reduce the air intake to the combustion engine; and
activating said at least one auxiliary brake so as to brake the combustion engine, if not already activated.

2. The method according to claim 1, wherein controlling the intake air throttle so as to reduce the air intake to the combustion engine comprises controlling the intake air throttle to a partially closed position.

3. The method according to claim 1, further comprising, in response to a determination that the rotational speed of the combustion engine is reduced below a threshold speed, controlling the intake air throttle so as to increase the air intake to the combustion engine.

4. The method according to claim 1, wherein said at least one auxiliary brake is an exhaust brake, and wherein activating the at least one auxiliary brake so as to brake the combustion engine is performed prior to, or simultaneously with, stopping fuel injection to the combustion engine.

5. The method according to claim 1, wherein said at least one exhaust brake is an electrical machine, and wherein the method further comprises controlling the electrical machine to apply a torque to the combustion engine according to a torque profile so as to dampen oscillations in a crankshaft of the combustion engine.

6. The method according to claim 1, wherein said at least one auxiliary brake is an electrical machine, and wherein the method further comprises controlling the electrical machine to apply a braking torque to the combustion engine according to a torque profile so as to dampen oscillations in a crankshaft of the combustion engine while reducing the rotational speed of the crankshaft.

7. A computer program product stored on a non-transitory computer-readable medium, said computer program product for shutting down a combustion engine of a powertrain of a vehicle wherein said vehicle comprises an intake air throttle arranged in an intake pipe of the combustion engine; and at least one auxiliary brake selected from the group consisting of: an exhaust brake and an electrical machine configured to operate as a generator, wherein said computer program product comprising computer instructions to cause one or more computer processors to perform the following operations:
stopping fuel injection to the combustion engine;
controlling the intake air throttle so as to reduce the air intake to the combustion engine; and
activating said at least one auxiliary brake so as to brake the combustion engine, if not already activated.

8. (canceled)

9. A control arrangement configured to shut down a combustion engine of a powertrain of a vehicle,
wherein said vehicle comprises:
an intake air throttle arranged in an intake pipe of the combustion engine; and
at least one auxiliary brake selected from the group consisting of; an exhaust brake and an electrical machine configured to operate as a generator,
the control arrangement being configured to, in response to a command for shutdown of the combustion engine:
stop fuel injection to the combustion engine;
control the intake air throttle so as to reduce the air intake to the combustion engine; and
activate said at least one auxiliary brake so as to brake the combustion engine, if not already activated.

10. A vehicle comprising:
a powertrain comprising a combustion engine,
an intake air throttle arranged in an intake pipe of the combustion engine;
at least one auxiliary brake selected from the group consisting of: an exhaust brake and an electrical machine configured to operate as a generator,
a control arrangement configured to, in response to a command for shutdown of the combustion engine:
stop fuel injection to the combustion engine;
control the intake air throttle so as to reduce the air intake to the combustion engine; and
activate said at least one auxiliary brake so as to brake the combustion engine, if not already activated.

11. The control arrangement according to claim 9, wherein controlling the intake air throttle so as to reduce the air intake to the combustion engine comprises controlling the intake air throttle to a partially closed position.

12. The control arrangement according to claim 9 further configured to, in response to a determination that the rotational speed of the combustion engine is reduced below a threshold speed, control the intake air throttle so as to increase the air intake to the combustion engine.

13. The control arrangement according to claim 9, wherein said at least one auxiliary brake is an exhaust brake, and wherein activating the at least one auxiliary brake so as to brake the combustion engine is performed prior to, or simultaneously with, stopping fuel injection to the combustion engine.

14. The control arrangement according to claim 9, wherein said at least one exhaust brake is an electrical machine, and wherein the control arrangement is further configured to control the electrical machine to apply a torque to the combustion engine according to a torque profile so as to dampen oscillations in a crankshaft of the combustion engine.

15. The control arrangement according to claim 9, wherein said at least one auxiliary brake is an electrical machine, and wherein the control arrangement is further configured to control the electrical machine to apply a braking torque to the combustion engine according to a torque profile so as to dampen oscillations in a crankshaft of the combustion engine while reducing the rotational speed of the crankshaft.

16. The vehicle according to claim 10, wherein controlling the intake air throttle so as to reduce the air intake to the combustion engine comprises controlling the intake air throttle to a partially closed position.

17. The vehicle according to claim 10, wherein the control arrangement is further configured to, in response to a determination that the rotational speed of the combustion engine is reduced below a threshold speed, control the intake air throttle so as to increase the air intake to the combustion engine.

18. The vehicle according to claim 10, wherein said at least one auxiliary brake is an exhaust brake, and wherein activating the at least one auxiliary brake so as to brake the combustion engine is performed prior to, or simultaneously with, stopping fuel injection to the combustion engine.

19. The vehicle according to claim 10, wherein said at least one exhaust brake is an electrical machine, and wherein the control arrangement is further configured to control the electrical machine to apply a torque to the combustion engine according to a torque profile so as to dampen oscillations in a crankshaft of the combustion engine.

20. The vehicle according to claim 10, wherein said at least one auxiliary brake is an electrical machine, and wherein the control arrangement is further configured to control the electrical machine to apply a braking torque to the combustion engine according to a torque profile so as to dampen oscillations in a crankshaft of the combustion engine while reducing the rotational speed of the crankshaft.
